(19) United States
(12) Patent Application Publication
(10) Pub. No.: US 2017/0018258 A1
(43) Pub. Date: Jan. 19, 2017

(54) Double-face Double-screen Smart Mobile Terminal

(71) Applicant: Wai Hong Yeung, Hong Kong (HK)

(72) Inventor: Wai Hong Yeung, Hong Kong (HK)

(21) Appl. No.: 15/124,362

(22) PCT Filed: Aug. 11, 2015
(86) PCT No.: PCT/CN2015/086586

§ 371 Date: Sep. 8, 2016

(30) Foreign Application Priority Data
Aug. 15, 2014 (CN) 201410404752.4

(51) Int. Cl. G09G 5/14; G09G 5/391; G06F 3/0488; G06F 3/041

(52) U.S. Cl. CPC G09G 5/14; G06F 3/0416; G09G 5/391; G06F 3/04883; H04M 1/72519

(57) ABSTRACT

Disclosed is a double-face double-screen smart mobile terminal, which comprises: a machine body (300), a main screen (100) and a secondary screen (200). The main screen (100) and the secondary screen (200) are respectively mounted on the front and back faces of the machine body (300), the main screen (100) and the secondary screen (200) share one microprocessor to respectively realize independent drive control of the main screen (100) and the secondary screen (200) via a main screen control module and a secondary screen control module which are divided inside the microprocessor; and at the same time, a switching control module in the microprocessor is used, and rapid switching of the main screen (100) and the secondary screen (200) is realized correspondingly according to a switching control instruction of a user, thereby effectively guaranteeing a display effect.

### FIELD OF THE INVENTION

The present invention relates to the technical field of electronic communications and, in particular, it concerns a double-face double-screen smart mobile terminal including a smartphone, a tablet computer and so on.

### BACKGROUND OF THE INVENTION

Global coverage of 3G networks makes the world get into the age of the Internet quickly and the application range of 4G networks is getting wider and wider. The networks become more and more close to the daily life and work of people. With the increase of market penetration of the smart mobile terminal, it becomes a driving force for the development of the mobile internet. Under this background, the smart mobile terminal has been paid more and more attention by consumers, and some of the smart terminals, such as smartphone, tablet computer and so on, are especially popular with consumers.

At present, the smartphone is not only used for calling someone, but also used for playing games, surfing the internet and so on, so as to meet the needs of different groups of consumers. However, the existing smartphone is provided with only one display screen, which causes inconvenience. When the user needs to switch between the different application programs, he/she must to stop or close the currently running application and then enter to the desired application. Such a switch will cause inconvenience for the users who are carrying out a real-time online operation, especially for the user who are playing an online game. When receiving an incoming call, text messages, information from an instant communication software (such as WeChat, MoMo and so on), the user needs to stop the game and take a few seconds or more time to reply the call or the message, thus it cause a poor user experience and it cannot meet the requirement of the user for a switch operation between different application interfaces.

### SUMMARY OF THE INVENTION

An object of the present invention is to provide a double-face double-screen smart mobile terminal, so as to solve the problem that the existing smart mobile terminal cannot realize the switch between different application interfaces quickly and easily when using.

To achieve the above object, there are provided technical solutions as follows:

A double-face double-screen smart mobile terminal, which includes: a machine body, which is provided with a circuit board fixedly mounted therein, the circuit board being welded with a microprocessor which is configured with a main screen control module, a secondary screen control module and a switching control module; a main screen, which is mounted on a front face of the machine body, electrically connected with the main screen control module of the microprocessor and used for generating a touch instruction according to a user operation and then sending the touch instruction to the microprocessor; and a secondary screen, which is mounted on a back face of the machine body, electrically connected with the secondary screen control module of the microprocessor and used for generating a touch instruction according to a user operation and then sending the touch instruction to the microprocessor. The microprocessor is used for analyzing and processing the touch instruction from the main screen or secondary screen so as to extract a switch instruction and then sending the switch instruction to the switching control module; and the switching control module is used for switching between a display interface of the main screen and a display interface of the secondary screen, according to the switch instruction.

Preferably, the microprocessor is further configured with a memory module, which is used for storing a screen resolution parameter for the main screen being used alone, a screen resolution parameter for the secondary screen being used alone and a screen resolution parameter for the main screen and the secondary screen being used simultaneously.

Preferably, the memory module is further used for storing a program of a current display interface of the main screen or the secondary screen.

Preferably, the touch instruction produced according to the user operation comprises an information produced by clicking the same position of the screen facing down continuously twice.

Preferably, the touch instruction produced according to the user operation comprises a graphics or a letter produced by sliding a finger across a current interface according to a preset slide track.

Preferably, the microprocessor is further configured with a detecting module, which is used for detecting a position relationship between the main screen and the secondary screen and then sending detection result to the microprocessor.

Preferably, a side of the machine body is provided with a first battery frame for installing a first battery and a second battery frame for installing a second battery.

According to the present invention, the double-face double-screen smart mobile terminal has a main screen and a secondary screen, which are respectively mounted on the front and back faces of the machine body. The main screen and the secondary screen share one microprocessor to respectively realize independent drive control of the main screen and the secondary screen via a main screen control module and a secondary screen control module which are divided inside the microprocessor; and at the same time, a switching control module in the microprocessor is used, and rapid switching of the main screen and the secondary screen is realized correspondingly according to a switching control instruction of a user. And the screen resolution is regulated and controlled according to the usage of the main screen and secondary screen, thereby effectively guaranteeing a display effect. Additionally, a drawer-type double-cell structure is provided to achieve a better battery life.

### BRIEF DESCRIPTION OF THE DRAWINGS

FIG. 1 is a perspective view of a double-face double-screen smart mobile terminal of the present invention;

FIG. 2 is a front view of the double-face double-screen smart mobile terminal of the present invention;

FIG. 3 is a rear view of the double-face double-screen smart mobile terminal of the present invention;

FIG. 4 is a schematic diagram showing the double-face double-screen smart mobile terminal of the present invention in use;

FIG. 5 is an exploded view of the double-face double-screen smart mobile terminal of the present invention; and

FIG. 6 is a block diagram of the double-face double-screen smart mobile terminal of the present invention.

Reference numbers in the figures: main screen 100; main screen protective cover 101; fixing plate 102; secondary screen 200; secondary screen protective cover 201; machine body 300; first battery frame 301; second battery frame 302; first battery 303; second battery 304; camera 400.

### DETAILED DESCRIPTION OF ILLUSTRATED EMBODIMENTS

The present invention will become more clearly by means of the following description combining the accompanying drawings, which are used to illustrate embodiments of the present invention.

The core concept of the present invention is: both of the front face and back face of the smartphone or tablet computer being provided with a display screen mounted thereon, the microprocessor provided in the machine body being divided into two independent control areas (corresponding to the main screen control module and the secondary screen control module of the present invention), and the main screen and the secondary screen being able to be driven and controlled by these two control areas, respectively.

With regard to the switch between the main screen and the secondary screen, it is determined by the position relationship between the main screen and the secondary screen. Firstly, determine whether the main screen is facing up or facing down by means of the microprocessor, if the main screen is facing up and the main screen has corresponding application running thereon, the user can carry out a switch operation such as touch the secondary screen twice continuously, so as to make the application running on the main screen be transferred to the secondary screen, and vice versa.

Or slide the finger across the main screen or secondary screen according to the presupposed slide track, so as to realize the switch between the main screen and secondary screen.

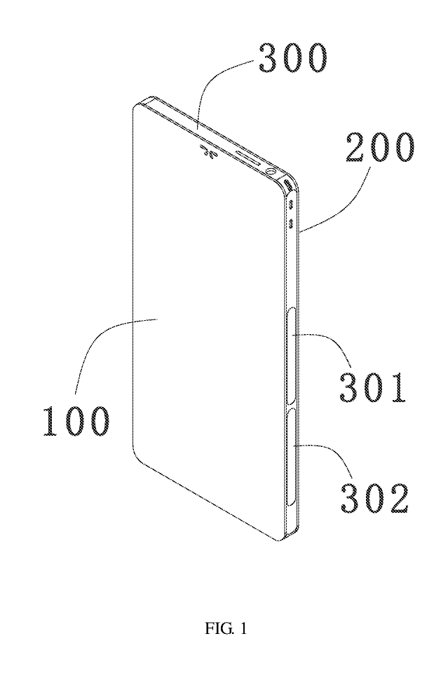

Referring to FIG. 1, it illustrates the structure of the double-face double-screen smart mobile terminal according to an embodiment of the present invention. In this embodiment, a smartphone is taken as an example to illustrate the present invention. The smartphone includes a machine body 300, a main screen 100 mounted on the front face of the machine body 300, a secondary screen 200 mounted on the back face of the machine body 300, a first battery frame 301 and a second battery frame, both of which are mounted on a side of the machine body 300.

The machine body 300 is provided with a circuit board fixedly mounted therein, the circuit board being welded with a microprocessor which is configured with a main screen control module (or main screen control circuit) for driving and controlling the main screen 100, a secondary screen control module for driving and controlling the secondary screen 200 and a switching control module for controlling the switch between the main screen 100 and the secondary screen 200.

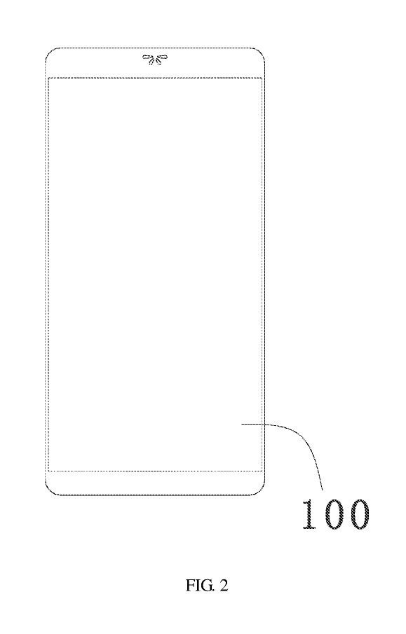

FIG. 2 is a front view of the double-face double-screen smart mobile terminal of the present invention. As shown in FIG. 2, the main screen 100 is mounted on the front face of the machine body 300, and the main screen 100 is a touch screen.

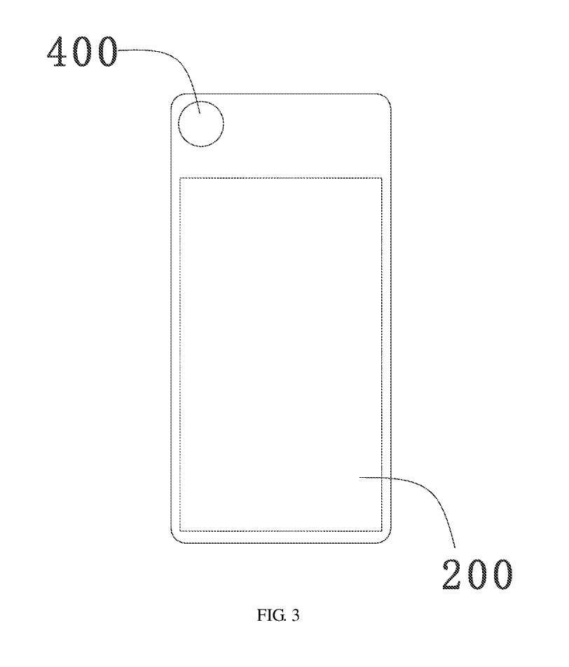

FIG. 3 is a rear view of the double-face double-screen smart mobile terminal of the present invention. As shown in FIG. 3, the secondary screen 200 is mounted on the back face of the machine body 300, and the secondary screen 200 is a touch screen. There further includes a camera 400 mounted on the back face of the machine body 300.

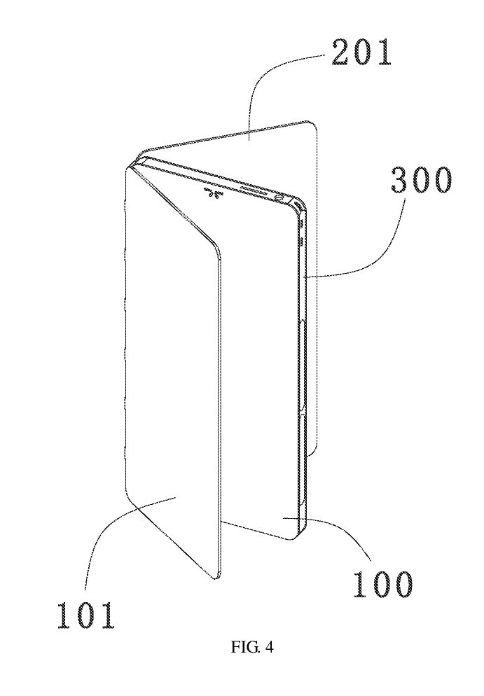

FIG. 4 is a schematic diagram showing the double-face double-screen smart mobile terminal of the present invention in use. As shown in FIG. 4, the outer side of the main screen 100 has a main screen protective cover 101 provided thereon; the outer side of the secondary screen 200 has a secondary screen protective cover 201 provided thereon; and the main screen protective cover 101 is connected together with the secondary screen protective cover 201.

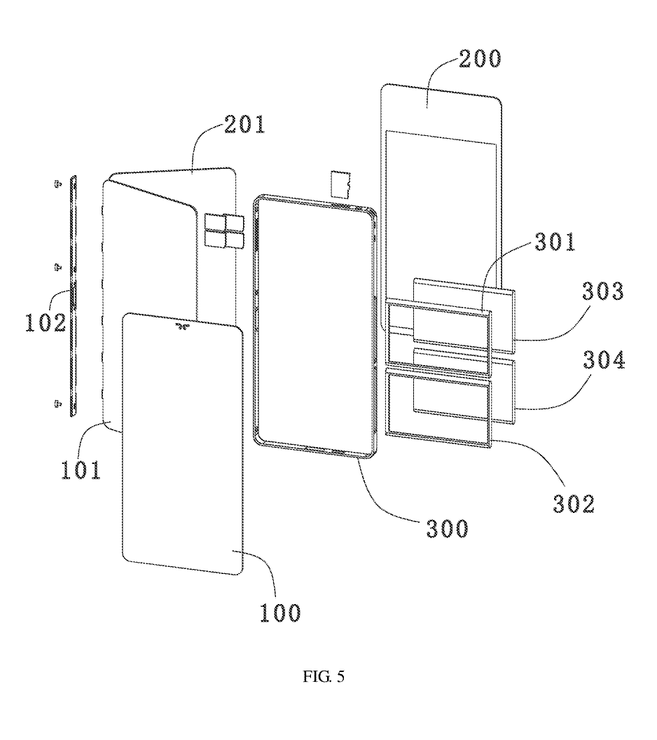

FIG. 5 is an exploded view of the double-face double-screen smart mobile terminal of the present invention. As shown in FIG. 5, both of the main screen protective cover 101 and the secondary screen protective cover 201 are fixed on a side of the machine body 300 by the fixing plate 102. The other side of the machine body 300 has a drawer-type first battery frame 301 and a drawer-type second battery frame 302. Accordingly, the first battery frame 301 has a first battery 303 installed therein and the second battery frame 302 has a second battery 304 installed therein, both of which are provided for supplying power to the main screen 100, the secondary screen 200 and the machine body 300.

According to the present invention, there are two screens provided on the front face and the back face, thus it needs large power when using the two screens at the same time. For this reasons, a drawer-type double-cell structure is provided on a side of the machine body, so as to achieve a better battery life and extend the service time of the double screens.

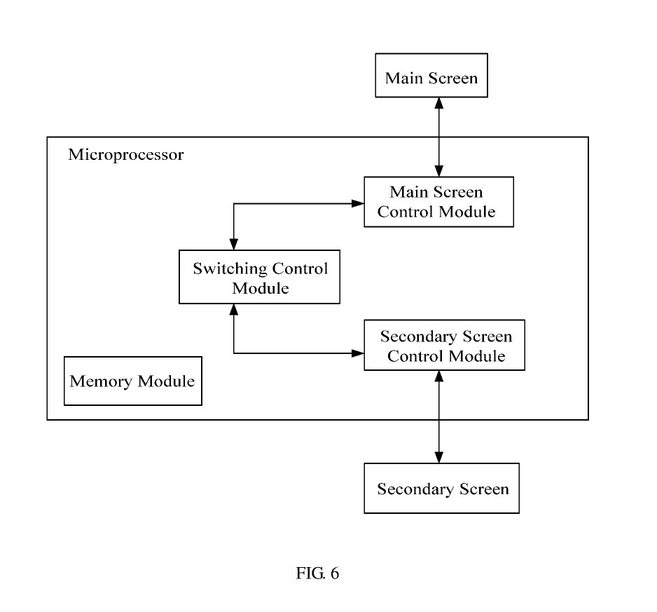

FIG. 6 is a block diagram of the double-face double-screen smart mobile terminal of the present invention. As shown in FIG. 6, the present invention includes a microprocessor, which is configured with a main screen control module, a secondary screen control module, a switching control module and a memory module. The main screen control module is connected to the main screen via the microprocessor, the secondary screen control module is connected to the secondary screen via the microprocessor, and the switching control module is connected with the main screen control module and the secondary screen control module, respectively.

Both of the main screen and the secondary screen are used for receiving an operation instruction of the user, generating a touch instruction according to the operation instruction of the user and then sending the touch instruction to the microprocessor. After analyzing and processing the touch instruction from the main screen or secondary screen, the microprocessor determines whether it meets the requirement of switch, if it meets the requirement, a switch instruction is produced and is extracted, and then the extracted switch instruction is sent to the switching control module. The switching control module is used for switching between a display interface of the main screen and a display interface of the secondary screen according to the switch instruction.

In some embodiments, when the main screen is facing up and the secondary screen is facing down, if the user continuously touches the screen facing down (secondary screen) the same position twice, a touch instruction will be generated. After receiving the instruction, the microprocessor carries out corresponding analysis and processing. If it meets the requirement of switch (the above operation is considered as a preset switch action), a switch instruction is produced and then sent to the switching control module. Under the control of the switching control module, the display interface of the main screen and the display interface of the secondary screen are switched, that is, the application interface displayed on the main screen is switched to the secondary screen, and the application interface displayed on the secondary screen is switched to the main screen.

When the secondary screen is not in working condition, the above method still can be used to achieve the switch of screens. The application running on the main screen can be switched to the secondary screen, and then a new application can be run on the main screen, thereby facilitating the users greatly. For example, if there is an incoming call when the user is playing an online game by using the main screen, the user just needs to double-click the secondary screen the same position, the application running on the main screen will be switched to the secondary screen, and then the main screen can be used to answer the phone. Both of the two screens can keep in a working state at the same time without affecting each other, and they are independent.

When both of the main screen and the secondary screen are in working state, they also can be switched. For example, when a QQ application is running on the main screen and a web application is running on the secondary screen, if the user needs to search information from the web site but do not want to shut down the QQ application or it is inconvenient to run the QQ application in the background, the user can double-click the secondary screen so as to make the QQ application be switched to the secondary screen, and then the web application is displayed on the main screen for facilitating a search operation.

In other embodiments, it also can be achieved by sliding the finger across the main screen or secondary screen according to the presupposed slide track. For example, the user can draw a letter such as C or U on the main screen or the secondary screen, so as to achieve the switch between the screens. It is achieved by the same principle as the above switch mode.

Anyway, the switch mode can be designed according to actual needs of the users, so as to achieve the corresponding objective.

Furthermore, the microprocessor of the present invention is further configured with a memory module, which is used for storing a screen resolution parameter for the main screen being used alone, a screen resolution parameter for the secondary screen being used alone and a screen resolution parameter for the main screen and the secondary screen being used simultaneously. When the main screen is used alone, the secondary screen is shut down. In this case, the main screen has four different screen resolution parameters including 1280*720, 1600*900, 1920*1080 and 2560*1440 for users to choose from. Similarly, this applies the same to the secondary screen when the secondary screen is used alone. When the main screen and the secondary screen are used simultaneously, either them can be chosen the same screen resolution, such as 1280*720, or can be chosen different screen resolutions, for example, choosing 1920*1080 for the main screen and choosing 1280*720 for the secondary screen.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A double-face double-screen smart mobile terminal, comprising:
a machine body, which is provided with a circuit board fixedly mounted therein, the circuit board being welded with a microprocessor which is configured with a main screen control module, a secondary screen control module and a switching control module;
a main screen, which is mounted on a front face of the machine body, electrically connected with the main screen control module of the microprocessor and used for generating a touch instruction according to a user operation and then sending the touch instruction to the microprocessor; and
a secondary screen, which is mounted on a back face of the machine body, electrically connected with the secondary screen control module of the microprocessor and used for generating a touch instruction according to a user operation and then sending the touch instruction to the microprocessor;
wherein the microprocessor is used for analyzing and processing the touch instruction from the main screen or secondary screen so as to extract a switch instruction and then sending the switch instruction to the switching control module; and the switching control module is used for switching between a display interface of the main screen and a display interface of the secondary screen, according to the switch instruction.

2. The double-face double-screen smart mobile terminal according to claim 1, wherein the microprocessor is further configured with a memory module, which is used for storing a screen resolution parameter for the main screen being used alone, a screen resolution parameter for the secondary screen being used alone and a screen resolution parameter for the main screen and the secondary screen being used simultaneously.

3. The double-face double-screen smart mobile terminal according to claim 2, wherein the memory module is further used for storing a program of a current display interface of the main screen or the secondary screen.

4. The double-face double-screen smart mobile terminal according to claim 1, wherein the touch instruction produced according to the user operation comprises an information produced by clicking the same position of the screen facing down continuously twice.

5. The double-face double-screen smart mobile terminal according to claim 1, wherein the touch instruction produced according to the user operation comprises a graphics or a letter produced by sliding a finger across a current interface according to a preset slide track.

6. The double-face double-screen smart mobile terminal according to claim 1, wherein the microprocessor is further configured with a detecting module, which is used for detecting a position relationship between the main screen and the secondary screen and then sending detection result to the microprocessor.

7. The double-face double-screen smart mobile terminal according to claim 1, wherein a side of the machine body is provided with a first battery frame for installing a first battery and a second battery frame for installing a second battery.
